(19) United States
(12) Patent Application Publication
(10) Pub. No.: US 2017/0046228 A1
(43) Pub. Date: Feb. 16, 2017

(54) REMOTE SECURE AUTOMATED SYSTEM RECOVERY, DEBUG, AND LOGGING

(71) Applicant: MaxLinear, Inc., Carlsbad, CA (US)

(72) Inventors: Saju Palayur, Carlsbad, CA (US); Brenndon Lee, Carlsbad, CA (US); Mariusz Murawski, Carlsbad, CA (US)

(21) Appl. No.: 15/235,271

(22) Filed: Aug. 12, 2016

Related U.S. Application Data
(60) Provisional application No. 62/204,846, filed on Aug. 13, 2015.

(51) Int. Cl. G06F 11/14; H04L 29/06; G06F 11/36; H04L 29/08

(52) U.S. Cl. CPC G06F 11/1415; H04L 67/10; H04L 67/42; H04L 63/0428; G06F 11/1451; G06F 11/3664; G06F 2201/84

(57) ABSTRACT

Systems and methods are provided for remote secure automated system recovery, debug, and logging. In particular, remote management circuits may be configured to support remote automated management of systems by remote entities, specifically to enable managing the systems during system crashes and/or when the systems may not be operating normally. Security measures may be utilized to ensure secure management. In particular, communication may be performed over encrypted links, with encryption and decryption being performed by the remote management circuits.

### CLAIM OF PRIORITY

This patent application makes reference to, claims priority to and claims benefit from U.S. Provisional Patent Application Ser. No. 62/204,846, filed Aug. 13, 2015. The above identified application is hereby incorporated herein by reference in its entirety.

### TECHNICAL FIELD

Aspects of the present disclosure relate to networking. More specifically, various implementations in accordance with the present disclosure relate to methods and systems for remote secure automated system recovery, debug, and logging.

### BACKGROUND

Conventional approaches for system recovery (e.g., firmware recovery) may be may be costly, cumbersome, and/or inefficient—e.g., requiring direct connections, mandating the user to be close to the system. Similarly, remote debugging systems, if any existed, may be costly, cumbersome, and/or inefficient—e.g., they may be complex, resource intensive, and/or may introduce security risks. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for remote secure automated system recovery, debug, and logging, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example communication setup in which remote secure automated system recovery, debug, and logging may be utilized.

FIG. 2 illustrates an example implementation for supporting secure automated system recovery and debug, in accordance with the present disclosure.

FIG. 3 illustrates another example implementation for supporting secure automated system recovery and debug, in accordance with the present disclosure.

FIG. 4 illustrates another example implementation for supporting secure automated system recovery and debug, in accordance with the present disclosure.

FIG. 5 illustrates another example implementation for supporting secure automated system recovery and debug, in accordance with the present disclosure.

FIG. 6 illustrates another example implementation for supporting secure automated system recovery and debug, in accordance with the present disclosure.

FIG. 7 illustrates another example implementation for supporting secure logging, in accordance with the present disclosure.

FIG. 8 illustrates an example scheme for storing secure keys, in accordance with the present disclosure.

FIG. 9 illustrates an example security scheme for use during secure automated system recovery and debug, in accordance with the present disclosure.

### DETAILED DESCRIPTION OF THE INVENTION

As utilized herein the terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.,” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

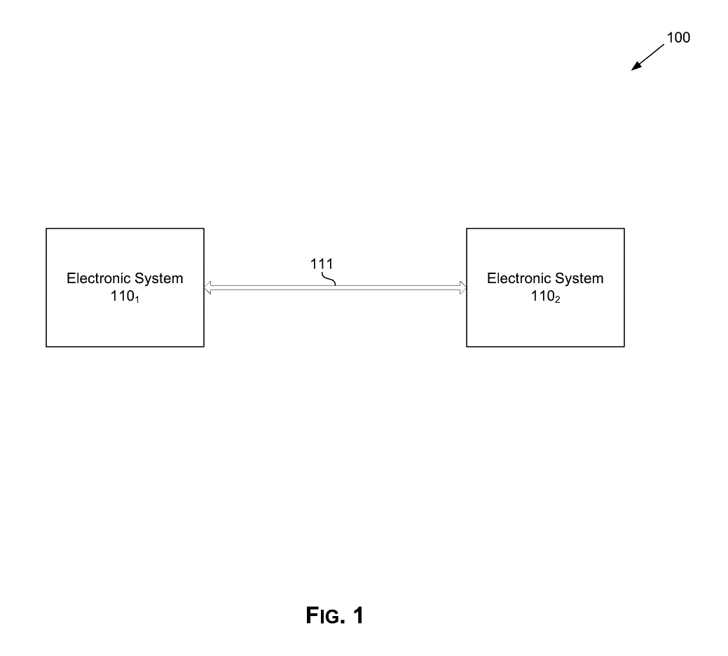

FIG. 1 illustrates an example communication setup in which remote secure automated system recovery, debug, and logging may be utilized. Shown in FIG. 1 is a communication setup 100, comprising electronic systems 110₁ and 110₂.

Each of the electronic systems 110₁ and 110₂ may comprise suitable circuitry for implementing various aspects of the present disclosure.

In some instances, the electronic systems 110₁ and 110₂ may be two separate electronic devices (or components thereof). Examples of electronic devices may comprise cellular and smart phones or similar handheld devices, tablets, personal computers, laptops or notebook computers, servers, personal media players, personal digital assistants, set top boxes, satellite receivers, wireless access points, cellular base stations, etc. In other instances, however, the electronic systems 110₁ and 110₂ may be components within the same system (e.g., an electronic device), configured to communicate with one another via particular internal interface. The disclosure is not limited, however, to any particular type of electronic system, and the various implementation described in this disclosure may apply to any electronic platform which may be operable or configured to performed the various tasks, functions, and/or operations described with respect to the electronic systems 110₁ and 110₂.

In some instances, the electronic systems 110₁ and 110₂ may support communications related operations. In this regard, the electronic systems 100 may support a plurality of wired and/or wireless interfaces and/or protocols, and may be operable to perform necessary processing operations to facilitate transmission and/or reception of signals over supported wired and/or wireless interfaces.

Examples of wireless standards, protocols, and/or interfaces which may be supported and/or used by the electronic systems 110₁ and 110₂ for communication therebetween may comprise wireless personal area network (WPAN) protocols (e.g., as Bluetooth (IEEE 802.15) and ZigBee), near field communication (NFC) standards, wireless local area network (WLAN) protocols (e.g., such as WiFi (IEEE 802.11) standards), cellular standards (including 2G/2G+, such as GSM/GPRS/EDGE, IS-95 or cdmaOne, etc., and 3G/3G+, such as CDMA2000, UMTS, and HSPA, etc.), 4G standards (e.g., WiMAX (IEEE 802.16) and LTE), Ultra-Wideband (UWB), Extremely High Frequency (EHF, such as 60 GHz) Digital TV Standards (e.g., DVB-T/DVB-H, and ISDB-T), etc.

Examples of wired standards, protocols, and/or interfaces which may be supported and/or used by the electronic systems 110₁ and 110₂ for communication therebetween may comprise Ethernet (IEEE 802.3), Digital Subscriber Line (DSL), Integrated Services Digital Network (ISDN), Fiber Distributed Data Interface (FDDI), cable television and/or internet access standards (e.g., ATSC, DVB-C, DOCSIS, etc.), in-home distribution standards such as Multimedia over Coax Alliance (MoCA), Universal Serial Bus (USB) based standards/protocols/interfaces, FSK (Frequency Shift Keying), etc.

In operation, the electronic systems 110₁ and 110₂ may communicate with each other, such as via one or more connections and/or links (e.g., connection/link 111). The connection/link 111 may be unidirectional, allowing for communications in only one direction (e.g., from the electronic system 110₁ to the electronic system 110₂), or may be bidirectional, allowing for communications in both directions—that is, from the electronic system 110₁ to the electronic system 110₂, and from the electronic system 110₂ to the electronic system 110₁). In this regard, bidirectional communications may be done concurrently in some instances. The communications between the electronic systems 110₁ and 110₂, such as over the connection/link 111, may comprise transmission and reception of signals, which may be utilized to carry data communicated between the electronic systems 110₁ and 110₂. The communicated signals may be setup, configured, and/or utilized in accordance with corresponding wired and/or wireless interfaces, protocols, and/or standards. In this regard, the electronic systems 110₁ and 110₂ may comprise suitable components configured to perform various functions or operations to facilitate the transmission and reception of signals.

In certain implementations, one of the electronic systems 110₁ and 110₂ may be used in supporting and/or providing centralized control, management, and/or servicing of one or more other electronic systems, including the other one of the electronic systems 110₁ and 110₂. For example, one of the electronic systems 110₁ and 110₂ (e.g., the electronic system 110₁) may be used at a centralized service facility (e.g., a data center) while the other one of the electronic systems 110₁ and 110₂ (e.g., the electronic system 110₂) may be a remote system managed and/or serviced by the centralized service facility. In such setup there may be, in some instances, a need for remote control of serviced systems. This may be needed, for example, where issues occur at the remote systems (e.g., crashes), such as to debug these issues, to recover systems, etc. Conventional solutions for remote control of systems, if any existed, may be lacking for low level (firmware) recovery, and as such solutions for remote secure automated system recovery, debug and/or logging may be desirable.

For example, remote systems may be configured to enable recovery of these systems when issues (e.g., crashes) occur. In this regard, certain remote systems (e.g., systems running resource-intensive operating systems) may have boot-loaders and code. Such boot-loaders and code may be stored, however, in non-ROM devices (e.g., flash memory) which are prone to data corruption. Further, these systems may have, or support manually localized modes for recovering the systems, such as using external media example USB storage device and a suitable component or device—e.g., universal asynchronous receiver/transmitter (UART) based component or device, etc. While the centralized service facility (e.g., data center) or systems therein may still be able to communicate with the remote systems (e.g., using suitable remote management protocol, such as TR-069), remote recovery and/or debugging of issues in the remote systems may not be possible if the startup software is corrupted. In other words, existing remote management solutions require the remote systems to be up and running, to run client-side functions. When the remote systems are down, however, there is no means for performing remote management operations, such as debugging, logging, etc.

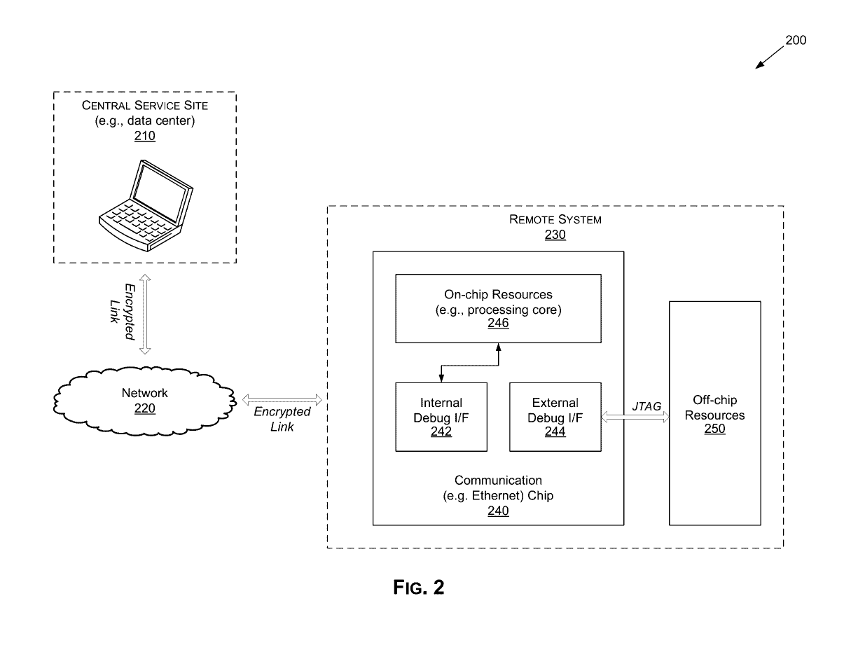

Accordingly, in various implementations in accordance with the present disclosure systems may allow recovery and/or debugging of remote systems that are in state where they may not be managed using currently available management protocols or standards, and to particularly to enable doing with as little change (and thus added complexity and/or cost) as possible to the remote systems are to-be managed or serviced. For example, remote systems may be automatically recovered remotely (e.g., over the Internet or any suitable network) such as using a remote debug interface over the existing connections—e.g., existing Ethernet connections, to eliminate a truck roll. Such automatic recovery and debugging solutions may utilize very generic connectivity, so that most of the intelligence (and thus cost—e.g., of the debug tools and related functions) may be at the centralized servicing sites (thus obviating the need and cost for such intelligence in each of the remote systems). Examples of various such implementations are described below, with respect to FIGS. 2-9.

In some example implementations, dedicated security measures may be taken to address and/or counteract particular security threats that may be pertinent to or may arise in remote access situations as would be the case when systems are being debugged and/or recovered remotely. Examples of possible security issues, and measures that may be incorporated in various example implementations of automatic remote recovery and debugging to mitigate or address these issues, may include: 1) eavesdropping, 2) denial-of-service attacks, 3) man-in-the-middle attacks, 4) close-in attacks, and 5) compromised keys.

In eavesdropping scenarios an attacker may be sniffing network traffic, such as to understand how to use the target device (the remote system). Eavesdropping related issues may be addressed by, for example, use of Pretty Good Privacy (PGP) encryption to secure network traffic against eavesdropping because the private key is transferred in the factory. These issues may also be address by, for example, increasing key size, which may help because learning long keys takes a long time (e.g., many years) and consumes substantial computing resources.

In denial-of-service attacks an attacker may flood the target device (the remote system) with large number (and various types) of network requests to cause high processing (CPU) load, thus leading to dropping legitimate packets. Denial-of-service attacks related issues may be addressed by, for example, configuring the target device (the remote system) to only accept a limited number of network debug packets per second (e.g., 10K packets/sec). Other mitigating measures may include adaptive dropping of packets—e.g., configuring the MAC layer/functions to automatically drop all packets that arrive on an incorrect port. Also, port hopping may be implemented and used, to continually change the port being used.

In man-in-the-middle attacks an attacker may alter valid data. Man-in-the-middle attacks related issues may be addressed by, for example, use of PGP encryption to secure the data.

In close-in attacks an attacker may get physical access to network connectors of the target device (the remote system). Close-in attacks related issues may be addressed by, for example, use of a unique timing pattern to the packet, which may enable the target device (the remote system) to determine that the packet is from a legitimate source. For example, the debug port may be shut down for a random time or until a truck roll. Further, use of PGP encryption may help as it may secure the data.

In compromised keys scenarios the communications (network and/or connectivity through it) may be secured but utilized secret keys used may be compromised, resulting in an attacker getting authenticated access to the target device (the remote system). Compromised keys related issues may be addressed by use of a unique timing pattern to the packets, as described above.

FIG. 2 illustrates an example implementation for supporting secure automated system recovery and debug, in accordance with the present disclosure. Shown in FIG. 2 is a communication arrangement 200, which comprises a central service site (e.g., data center) 210, a network 220, and a remote system 230.

The remote system 230 may be substantially similar to the electronic system 110 of FIG. 1; particularly one that is being managed, serviced, and/or controlled by a centralized entity—e.g., the central service site 210. The central service site 210 may comprise suitable resources (e.g., one or more electronic systems, similar to the electronic system 110 of FIG. 1) that may be used in managing, servicing, and/or controlling remote systems, such as the remote system 230.

The network 220 may comprise a system of interconnected resources (hardware, software, etc.) for facilitating exchange and/or forwarding of data (including performing such functions as, e.g., routing, switching, etc.) among a plurality of nodes, based on one or more networking standards, and/or with the data being embedded into messages or structured in accordance with particular standards or protocols (e.g., as Ethernet packets). Physical connectivity within, and/or to or from the network 220, may be provided via copper wires, fiber-optic cables, wireless links (including satellite links), and/or other standards-based interfaces. Accordingly, communications between the remote system 210 and the central service site 210 may be done via the network 220, particularly using encrypted links for added security.

The remote system 230 may be configured to support remote automated system recovery and debugging, particularly from the central service site 210 (e.g., by an operator or administrator using a suitable computer system therein). In particular, the remote system 230 may, as minimally as possible, comprise suitable components (hardware and/or software) and/or may be configured to implement functions which may enable debugging of any issues in the remote system 230 and/or recovery of the remote system 230 (e.g., should it crash or run into issues preventing or degrading its operation) from the central service site 210. The remote system 230 may comprise, for example, a communication (e.g., Ethernet) chip 240, which may incorporate the components and/or functions supporting the remote secure automated system recovery and debugging.

For example, in the particular implementation depicted in FIG. 2, the communication chip 240 may comprise an internal debug interface (I/F) block 242 and an external debug interface (I/F) block 244. The internal debug I/F block 242 may comprise suitable circuitry for capturing, processing, and/or routing of messages (e.g., Ethernet packets) that are used in communicating debug requests (e.g., from the central service site 210), which are targeted for on-chip resources 246 (e.g., processing (CPU) core of the communication chip 240 itself). Similarly, the external debug I/F block 244 may comprise suitable circuitry for capturing, processing, and/or routing of messages (e.g., Ethernet packets) that are used in communicating debug requests (e.g., from the central service site 210), which are targeted for off-chip resources 250 within the remote system 230 (e.g., other hardware devices or components besides the communication chip 240). The internal debug I/F block 242 and the external debug I/F block 244 may identify messages as being a debug (or logging, recovery, etc.) related message based on particular criteria. For example, messages used in remote secure system recovery, debugging, and/or logging may be of particular type (e.g., UDP datagrams) communicated in particular manner (e.g., particular UDP port).

Thus, remote debugging of the on-chip resources 246 may be done by sending via the network 220 packets (e.g., Ethernet packet), over the encrypted links, carrying debug messages. These packet may be filtered or captured via the internal debug I/F block 242, and applied thereby to the on-chip resources 246. The same path may be used to trigger logging of information relating to the on-chip resources 246.

Remote debugging of the off-chip resources 250 may be done by sending via the network 220 packets (e.g., Ethernet packet), over the encrypted links, carrying debug messages, which may be filtered or captured via the external debug I/F block 244, and applied thereby to the off-chip resources 250, such as using Joint Test Action Group (JTAG) based interface/communications. The same path may be used to trigger logging of information relating to the off-chip resources 250.

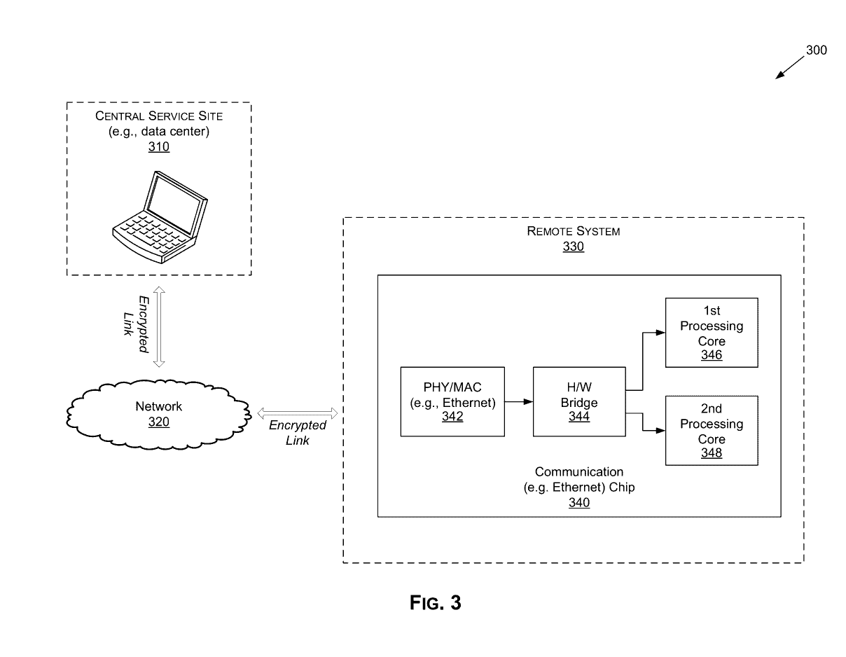

FIG. 3 illustrates another example implementation for supporting secure automated system recovery and debug, in accordance with the present disclosure. Shown in FIG. 3 is a communication arrangement 300, which comprises a central service site (e.g., data center) 310, a network 320, and a remote system 330.

Each of the central service site 310, the network 320, and the remote system 330 may be substantially similar to the corresponding, similarly named elements in FIG. 2—that is, the central service site 210, the network 220, and the remote system 230, and may operate in a substantially similar manner. Accordingly, as with the remote system 230 and the central service site 210, the remote system 330 may also support and/or enable remote automated system recovery and debugging, particularly via the central service site 310 (e.g., by an operator or administrator using a suitable computer system therein). Nonetheless, the remote system 330 may represent an alternative implementation for providing the required functions and/or operations in support of secure remote automated system recovery and debugging.

For example, as with the remote system 230, the remote system 330 may also comprise a communication (e.g., Ethernet) chip 340, which may incorporate suitable components (hardware and/or software) and/or may implement functions supporting the remote secure automated system recovery and debugging. In the particular implementation depicted in FIG. 3, however, the communication chip 340 may comprise a physical layer (PHY) and medium access control (MAC) block 342 and a hardware bridge block 344.

The PHY/MAC block 342 may comprise suitable circuitry for processing packets, particularly applying physical layer (PHY) based processing, such as to enable identifying particular type of messages—e.g., messages corresponding to debug, logging, and/or system recovery related messages (e.g., requests and/or commands from the central service site 310). The PHY/MAC block 342 maybe configured to process the received packets in accordance with their type—e.g., providing Ethernet PHY/MAC processing when the received packets are Ethernet packets. These messages may be targeted to certain components, such as one of two processing (CPU) cores 346 and 348 of the communication chip 340. The PHY/MAC block 342 may comprise, for example, a hardware packet filter which may be configured to route all packets meeting particular criteria (e.g., being UDP based packets, received on a particular preconfigured UDP port), such as to the hardware bridge 344.

The hardware bridge block 344 may comprise suitable circuitry for directing debugging, logging, and/or system recovery related messages to particular components, such as one of the processing (CPU) cores 346 and 348. For example, the hardware bridge block 344 may be configured as debug-based (e.g., JTAG) hardware element for connecting to and/or interacting CPU cores.

Accordingly, remote debugging and/or recovery of the processing (CPU) cores 346 and 348 may be done by sending via the network 320 packets (e.g., Ethernet packet), over the encrypted links, carrying debug messages, which may be routed via the PHY block 342 to the hardware bridge block 344, which may then provide the necessary interfacing (e.g., JTAG-based) to the correct one of the processing (CPU) cores 346 and 348.

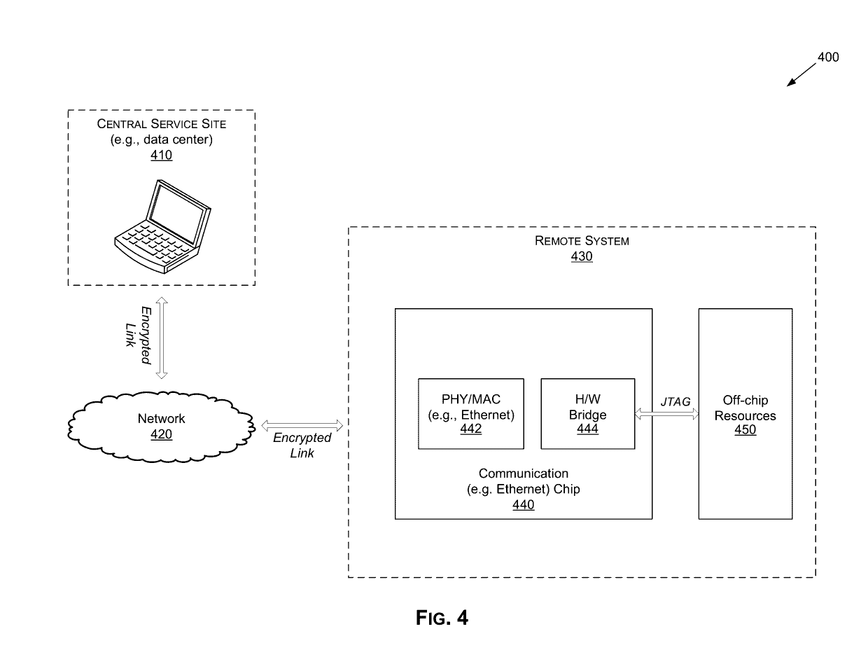

FIG. 4 illustrates another example implementation for supporting secure automated system recovery and debug, in accordance with the present disclosure. Shown in FIG. 4 is a communication arrangement 400, which comprises a central service site (e.g., data center) 410, a network 420, and a remote system 430.

Each of the central service site 410, the network 420, and the remote system 430 may be substantially similar to the corresponding, similarly named elements in FIG. 3—that is, the central service site 310, the network 320, and the remote system 330, and may operate in a substantially similar manner. Accordingly, as with the remote system 330 and the central service site 310, the remote system 430 may also support and/or enable remote automated system recovery and debugging, particularly via the central service site 410 (e.g., by an operator or administrator using a suitable computer system therein, or automatically running recovery scripts using a suitable computer).

As with the remote system 330, the remote system 430 may also comprise a communication (e.g., Ethernet) chip 440, which may incorporate suitable components (hardware and/or software) and/or may implement functions supporting the remote secure automated system recovery and debugging. Further, the communication chip 440 may also comprise a PHY/MAC block 442 and a hardware bridge block 444, which may be substantially similar to the PHY/MAC block 342 and the hardware bridge block 344 of FIG. 3, and may also operate in a substantially similar manner. The hardware bridge block 444, however, may provide debug-based (e.g., JTAG) interfacing with off-chip resources 450 in the remote system 450. In this regard, the hardware bridge block 444 may be configured as a JTAG-based hardware element for connecting to and/or interacting with off-chip resources 450. Thus, remote debugging and/or recovery of the processing (CPU) cores 446 and 448 may be done by sending via the network 420 packets (e.g., Ethernet packet), over the encrypted links, packets carrying debug messages, which may be routed via the PHY block 442 to the hardware bridge block 444, which may then provide the necessary interfacing (e.g., JTAG-based) to the off-chip resources 450.

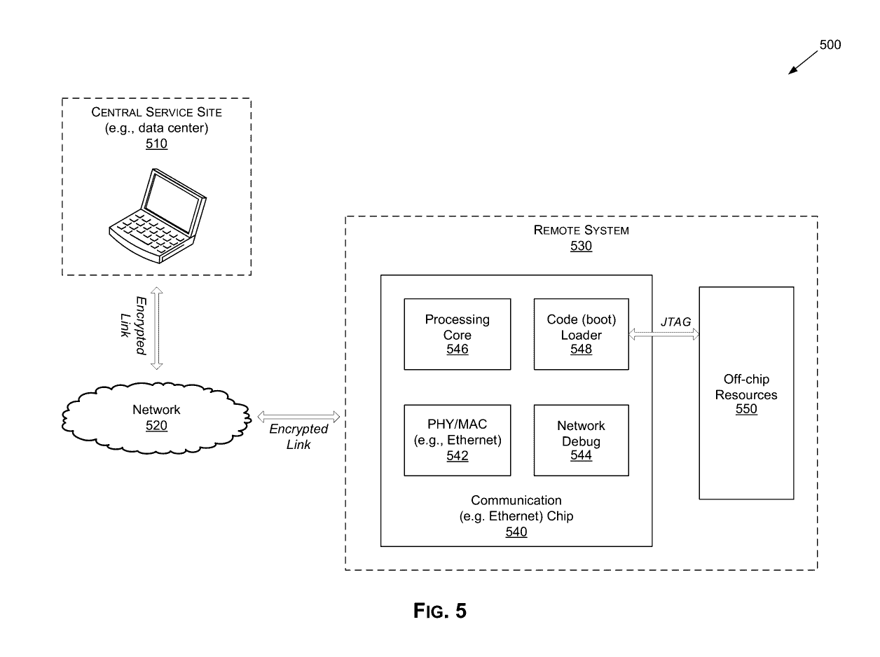

FIG. 5 illustrates another example implementation for supporting secure automated system recovery and debug, in accordance with the present disclosure. Shown in FIG. 5 is a communication arrangement 500, which comprises a central service site (e.g., data center) 510, a network 520, and a remote system 530.

Each of the central service site 510, the network 520, and the remote system 530 may be substantially similar to the corresponding, similarly named elements in FIG. 2—that is, the central service site 210, the network 220, and the remote system 230, and may operate in a substantially similar manner. Accordingly, as with the remote system 230 and the central service site 210, the remote system 530 may also support and/or enable remote automated system recovery and debugging, particularly via the central service site 510 (e.g., by an operator or administrator using a suitable computer system therein, or automatically running recovery scripts using a suitable computer). Nonetheless, the remote system 530 may represent an alternative implementation for providing the required functions and/or operations in support of secure remote automated system recovery and debugging.

For example, as with each of the prior remote systems (230, 330, and 430), the remote system 530 may also comprise a communication (e.g., Ethernet) chip 540, which may incorporate hardware suitable components (hardware and/or software) and/or may implement functions supporting remote secure automated system recovery and debugging. In the particular implementation depicted in FIG. 5, however, the communication chip 540 may comprise a PHY block 542, a network debug block 544, an on-chip processing (e.g., CPU) core 546, and a code (e.g., boot) loader block 548.

The PHY/MAC block 542 may be substantially similar to the PHY/MAC block 342 of FIG. 3, and may also operate in substantially similar manner. In this regard, the PHY block 542 may be operable to identify packets corresponding to debugging, logging, and/or system recovery related messaging (e.g., requests and/or commands from the central service site 510), and to route these packets, such as to the network debug block 544.

The network debug block 544 may comprise suitable circuitry for processing and/or handling debug-related messages. In particular, the network debug block 544 may be configured to handle messages used by a remote entity (e.g., data center 510) in debugging and/or recovery of various components of the remote system 530, particularly the off-chip resources 550. This may be done using the on-chip processing (CPU) core 546 and the code (boot) loader block 548. In this regard, network debug block 544 may identify network packets that are used for such debugging and/or recovery, with the packets being identified based on having a particular type (e.g., UDP) and/or being received in particular (at some preconfigured UDP port). The identified network packets may then be passed to the on-chip processing (CPU) core 546 for processing thereby, which may then interact with the off-chip resources via the code (boot) loader block 548. In this regard, the code (boot) loader block 548 may be used to bridge to the off-chip resources 550, such as using General-purpose input/output (GPIO) pins on communication chip 540. Debug tools running in the data center 510 may then download necessary function (e.g., firmware) to internal memory of the communication chip 540 to enable it to run a software bridge to the off-chip resources 550 (which may then be used in debugging and/or recovery).

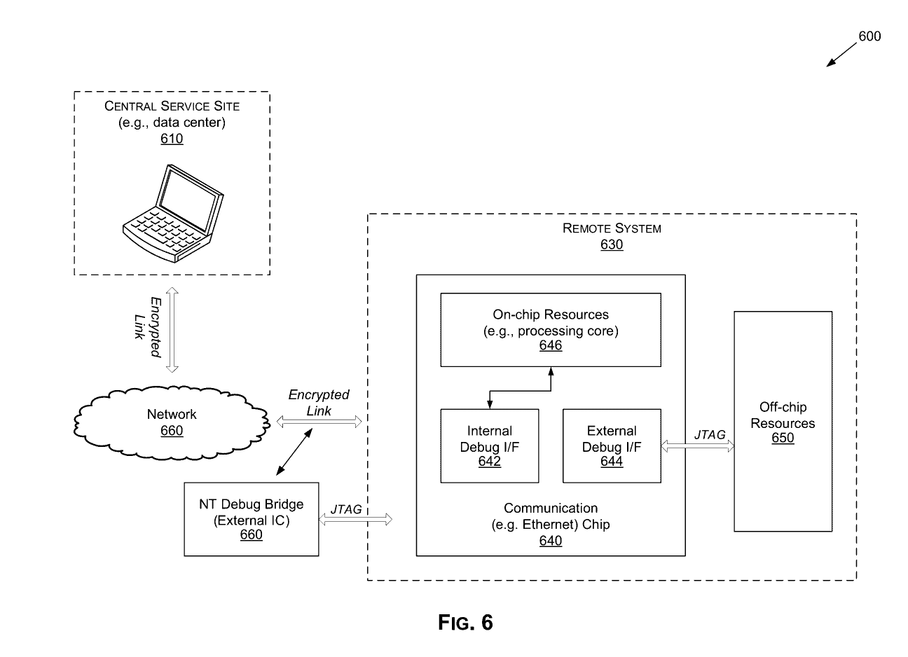

FIG. 6 illustrates another example implementation for supporting secure automated system recovery and debug, in accordance with the present disclosure. Shown in FIG. 6 is a communication arrangement 600, which comprises a central service site (e.g., data center) 610, a network 620, a remote system 630, and a network debug bridge 660.

Each of the central service site 610, the network 620, and the remote system 630 may be substantially similar to the corresponding, similarly named elements in FIG. 2—that is, the central service site 210, the network 220, and the remote system 230, and may operate in substantially similar manner. Accordingly, as with the remote system 230 and the central service site 210, the remote system 630 may also support and/or enable remote automated system recovery and debugging, particularly via the central service site 610 (e.g., by an operator or administrator using a suitable computer system therein, or automatically running recovery scripts using a suitable computer). Nonetheless, the remote system 630 may represent an alternative implementation for providing the required functions and/or operations in support of secure remote automated system recovery and debugging.

For example, as with each of the prior remote systems (230, 330, and 430), the remote system 630 may also comprise a communication (e.g., Ethernet) chip 640, which may incorporate suitable components (hardware and/or software) and/or may implement functions supporting the remote secure automated system recovery and debugging. In the particular implementation depicted in FIG. 6, however, the communication chip 640 may be implemented in a substantially similar manner as the communication chip 240—also comprising an internal debug interface (I/F) block 642 and an external debug interface (I/F) block 644, which may be substantially similar to the internal debug I/F block 242 and the external debug I/F block 244, respectively, and may be configured and/or may operate in a substantially similar manner in facilitating remote debugging and/or recovery of on-chip resources 646 and off-chip resources 650.

In the implementation illustrated in FIG. 6, however, handling the packets carrying the debugging, logging, and/or recovery related messages may be done by network debug bridge 660. In this regard, the network debug bridge 660 may comprise suitable circuitry identifying and processing packets carrying such debugging, logging, and/or recovery messaging, such as in the same manner described with respect to any of the PHY blocks in the prior figures. Further, the network debug bridge 660 may be operable to utilize debug-based (e.g., JTAG) interfacing to the Ethernet chip 640, such as over suitable serial interface. The messaging can then be handled within the communication chip 640 based on the target component—e.g., by the internal debug I/F block 242 for on-chip resources 646, and by the external debug I/F block 244 for any of the off-chip resources 650.

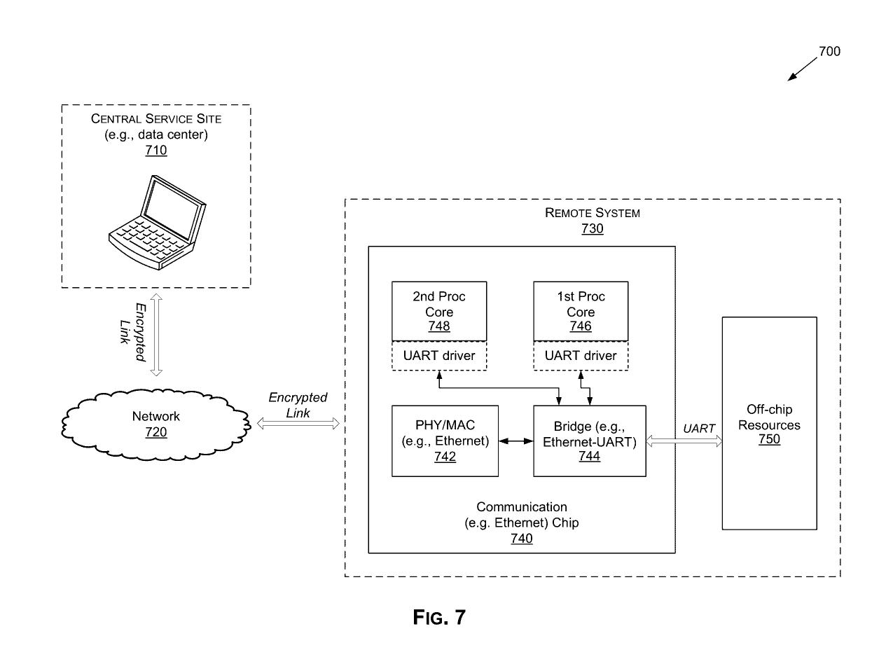

FIG. 7 illustrates another example implementation for supporting secure logging, in accordance with the present disclosure. Shown in FIG. 7 is a communication arrangement 700, which comprises a central service site (e.g., data center) 710, a network 720, and a remote system 730.

Each of the central service site 710, the network 720, and the remote system 730 may be substantially similar to the corresponding, similarly named elements in FIG. 2—that is, the central service site 210, the network 220, and the remote system 230, and may operate in substantially similar manner. Accordingly, as with the remote system 230 and the central service site 210, the remote system 730 may also support and/or enable remote automated system recovery and debugging, particularly via the central service site 710 (e.g., by an operator or administrator using a suitable computer system therein). Nonetheless, the remote system 730 may represent an alternative implementation for providing the required functions and/or operations in support of secure remote automated system recovery and debugging.

For example, as with any of the previous remote systems (230, 330, 430, 730, and 630), the remote system 730 may also comprise a communication (e.g., Ethernet) chip 740, which may incorporate suitable components (hardware and/or software) and/or may implement functions supporting the remote secure automated system recovery and debugging. In the particular implementation depicted in FIG. 7, however, the communication chip 740 may comprise a PHY block 742 and a bridge (e.g., Ethernet-to-UART) block 744.

The PHY/MAC block 742 may be substantially similar to the PHY/MAC block 342 of FIG. 3, and may also operate in substantially similar manner. In this regard, the PHY/MAC block 742 may be operable to identify packets corresponding to debugging, logging, and/or system recovery related messaging (e.g., requests and/or commands from the central service site 710), which may be directed to certain components, such as one of two processing (CPU) cores 746 and 748 of the communication chip 340 itself and/or to any of off-chip resources 750 of the remote system 730. The PHY/MAC block 742 may route the identified packets, such as to the bridge block 744.

The bridge block 744 may comprise suitable circuitry for handling debugging, logging, and/or system recovery related messages, such as to facilitate interfacing with the corresponding target components, such as one of the processing (CPU) cores 746 and 748, and/or any of the off-chip resources 750. The interfacing between the bridge block 744 and the target components may be performed using, e.g., UART-based interactions. Thus, where necessary (e.g., for the processing (CPU) cores 746 and 748), UART drivers may be incorporated into the target components to support the UART-based communications.

Accordingly, remote debugging and/or recovery of the remote system 730 may be done by sending via the network 720 packets (e.g., Ethernet packet), over the encrypted links, packets carrying debug messages, which may be routed via the PHY/MAC block 742 to the bridge block 744, which may then provide the necessary interfacing (e.g., UART-based) to the corresponding component(s).

While the implementations depicted in FIGS. 2-7 are described independently and/or separately, the disclosure is not limited. Accordingly, in some instances features corresponding to two or more of these implementations may be combined and/or used together in a particular implementation.

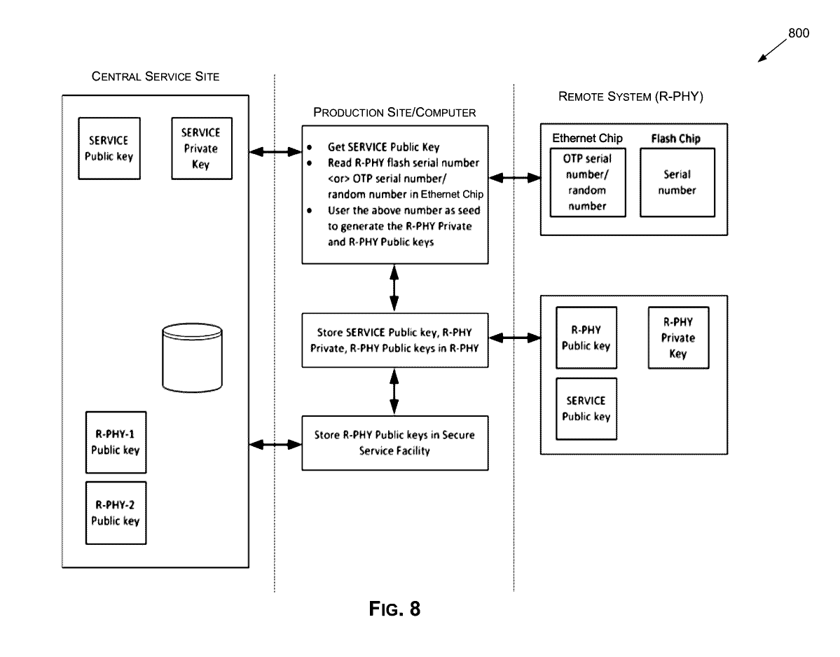

FIG. 8 illustrates an example scheme for storing secure keys, in accordance with the present disclosure. Shown in FIG. 8 is a scheme 800 for storing the various elements required to provide remote secure automated system recovery, debug, and logging.

In particular, the scheme 800 may be used to facilitate setting and/or exchanging information (e.g., encryption keys and the like) in or between a central service site (e.g., any one of the central service sites 210, 310, 410, 510, 610, and 710) and a remote system (e.g., any one of the remote systems 230, 330, 430, 530, 630, and 730), referred to hereafter as R-PHY, to enable establishing and utilizing secure communications therebetween during the remote secure automated system recovery, debug, and logging. For example, in some instances the remote secure automated management comprises use of debug links which may be secured with PGP encryption, we can decide on 128-bit encryption. Thus, scheme 800 may comprise performing the necessary key exchange required to allow setting up such secure encrypted links.

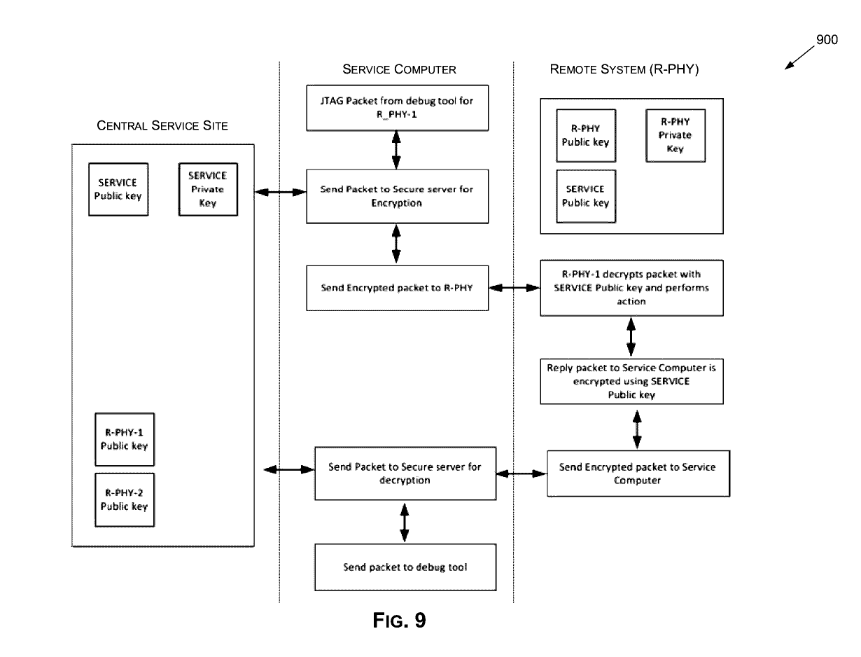

The key exchange may be performed at a production site (where the R-PHY is being produced or manufactured), particularly by a computer system at that site (“production computer”). The production computer may request and receive particular encryption information from the central service site (e.g., service public key). The production computer may then obtain identification information relating to the R-PHY or components thereof—e.g., identification information (e.g., serial number, etc.) relating to communication chip in the R-PHY, which is used in setting up and facilitating communications; identification information for a flash chip used for storage (e.g., code, such as boot code, etc.) in the R-PHY; etc. The service public key and the R-PHY identification information may then be used (e.g., as seeds) in generating encryption information for the R-PHY (e.g., public and private keys). The service public key and the R-PHY private and public keys may then be stored into the R-PHY. Further, the R-PHY private and public keys may be communicated to the central service site, where it may be stored for future use, such as in a database storing similar information for a plurality of remote systems (e.g., R-PHY-1, R-PHY-2, . . . ). The keys may then be used thereafter in remote secure automated system recovery, debug, and logging. An example use scenario is described in more detail with respect to FIG. 9.

FIG. 9 illustrates an example security scheme for use during secure automated system recovery and debug, in accordance with the present disclosure. Shown in FIG. 9 is a scheme 900 for setting up and using a secured debug session during remote secure automated system recovery, debug, and logging operations.

In particular, the scheme 900 may be implemented at a central service site (e.g., any one of the central service sites 210, 310, 410, 510, 610, and 710), such as via a debug tool running on a service computer therein, to run a secured debug session into a remote system (e.g., any one of the remote systems 230, 330, 430, 530, 630, and 730), referred to hereafter as R-PHY-1. In this regard, the scheme 900, as illustrated in FIG. 9, is presumably implemented and/or run after the necessary setup operations (e.g., exchange of keys in accordance with scheme 800, as illustrated in FIG. 8).

For example, packets (e.g., JTAG-based) may be generated via the debug tool in the service computer, targeted for R-PHY-1. The packets may be sent for encryption to a suitable component (e.g., a secure server) in the central service site, which may perform the necessary encryption using the service key(s) and previously stored encryption keys corresponding to the particular remote system—that is R-PHY-1. Once received back from the secure server, the service computer may send the encrypted packet to R-PHY-1. When R-PHY-1 receives the encrypted packet, it may decrypt using previously stored encryption related information (e.g., its own private and public key, and service public key), and upon successful decryption, may undertake the indicated action (e.g., debugging particular component, etc.).

When handling of the action is complete, if necessary or required, R-PHY-1 may generate a response packet, which may encrypted—e.g., using the same encryption information noted above. The encrypted response packet is then sent back to the service computer, which may forward it to the secure server of the central service site for decryption thereby. The decrypted packet is then returned from the secure server to the service computer, which sends it to the debug tool.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An apparatus comprising:
one or more circuits that are configured to support remote automated management of a system by a remote entity, to enable managing the system during system crashes and/or when the system is not operating normally, the one or more circuits being operable to:
receive management related messages from the remote entity;
process the received management related messages; and
perform one or more functions corresponding to handling of the received management related messages, wherein the one or more functions pertain to recovery, debugging, and/or logging of the system.

2. The apparatus of claim 1, wherein the one or more circuits are operable to, when receiving management related messages:
receive communication packets configured for communication over particular medium and/or in accordance with a particular communication protocol;
determine whether the received communication packets are associated with remote automated management; and
determine whether the management related requests are directed to the system or a component thereof.

3. The apparatus of claim 2, wherein the received communication packets comprise Ethernet packets.

4. The apparatus of claim 2, wherein the one or more circuits are operable to determine whether the received communication packets are associated with remote automated management based on a type of communication packets and/or a port on which the communication packets are received.

5. The apparatus of claim 4, wherein the one or more circuits are operable to determine that the received communication packets are associated with remote automated management when the communication packets comprise User Datagram Protocol (UDP) packets received an a predefined UDP port.

6. The apparatus of claim 2, wherein the one or more circuits are operable to, after identifying the received communication packets as being associated with remote automated management, process the received communication packets to extract management related requests carried therein.

7. The apparatus of claim 1, wherein the one or more circuits are operable to update or modify one or more functions in the system based on the received management related messages.

8. The apparatus of claim 1, wherein the one or more circuits are operable to communicate with the remote entity via one or more encrypted links.

9. The apparatus of claim 8, wherein the management related messages are embedded in encrypted packets; and wherein the one or more circuits are operable to apply decryption to the encrypted packets.

10. The apparatus of claim 1, wherein at least one of the one or more circuits is incorporated into the system.

11. The apparatus of claim 1, wherein at least one of the one or more circuits is incorporated into an Ethernet chip.

12. The apparatus of claim 1, wherein at least one of the one or more circuits is incorporated into an external component connected to the system.

13. The apparatus of claim 12, wherein the at least one of the one or more circuits is incorporated into the external component and is configured for handling the communication with the remote entity, and for generating debugging related messages based on the received management related messages.

14. An method comprising:
receiving, via a dedicated management component in a system, related messages from a remote entity, wherein the dedicated management component is configured for supporting remote automated management to enable managing the system during system crashes and/or when the system is not operating normally;
processing the received management related messages; and
performing one or more functions corresponding to handling of the received management related messages, wherein the one or more functions pertain to recovery, debugging, and/or logging of the system.

15. The method of claim 14, comprising, when receiving management related messages:
receiving communication packets configured for communication over particular medium and/or in accordance with a particular communication protocol;
determining whether the received communication packets are associated with remote automated management; and
determining whether the management related requests are directed to the system or a component thereof.

16. The method of claim 15, comprising determining whether the received communication packets are associated with remote automated management based on a type of communication packets and/or a port on which the communication packets are received.

17. The method of claim 15, comprising, after identifying the received communication packets as being associated with remote automated management, process the received communication packets to extract management related requests carried therein.

18. The method of claim 14, comprising updating or modifying one or more functions in the system based on the received management related messages.

19. The method of claim 14, comprising communicating with the remote entity via one or more encrypted links.

20. The method of claim 19, wherein the management related messages are embedded in encrypted packets, and comprising applying decryption to the encrypted packets.
